(19) United States
(12) Patent Application Publication
(10) Pub. No.: US 2017/0095976 A1
(43) Pub. Date: Apr. 6, 2017

(54) Hand-Held Three-Dimensional Drawing Device

(71) Applicant: Tech 4 Kids Inc., Mississauga (CA)

(72) Inventors: Bradley D. Pedersen, Mississauga (CA); Kyle Jeffs, Mississauga (CA)

(73) Assignee: Tech 4 Kids Inc., Mississauga (CA)

(21) Appl. No.: 15/062,437

(22) Filed: Mar. 7, 2016

Related U.S. Application Data
(60) Provisional application No. 62/235,627, filed on Oct. 1, 2015.

(51) Int. Cl. B29C 67/00

(52) U.S. Cl. CPC B29C 67/0085; B33Y 30/00

(57) ABSTRACT

A three-dimensional (3D) drawing device having a housing configured for manipulation by a user's hand. The drawing device has a nozzle assembly with an exit nozzle and a manual mechanism used to expel a UV gel that hardens when exposed to a UV light source that is secured to the end of the device.

### CROSS-REFERENCE TO RELATED INVENTIONS

The present invention is a non-provisional application claiming the benefit of provisional application Ser. No. 62/235,627 filed on Oct. 1, 2015.

### FIELD OF THE INVENTION

The present disclosure relates to a hand-held implement configured to extrude a gel used to print or create three-dimensional (3D) objects.

### BACKGROUND OF THE INVENTION

Three-dimensional printers are known and are used to produce 3D items. These printers operate by deposited sequential layers of plastic or solidification of layers of a precursor material. These printers tend to be large and expensive and require the design to be provided as a computer file, for example as generated by a Computer-Aided Design (CAD) program. There are also hand-held devices that are able to produce and print 3D items. However, these also tend to be extremely expensive and cumbersome to use. It is therefore desirable to provide a hand-held device to form 3D items without the need of expensive 3D printers or expensive hand-held devices.

### SUMMARY OF THE INVENTION

It is desirable to provide a reliable, easily refillable hand-held device to form 3D items without the need for computerized design files. The present disclosure describes a hand-held device that allows a user to “draw” a 3D structure.

In one embodiment there is a hand-held instrument for creating a 3-dimensional object. The instrument includes a hand-held elongated body having a tip end and a base end. At least one UV LED light source is positioned about the tip end. The UV LED light source selectively forms an electrical circuit with a battery contained within said body and a switch actuated externally from the body. A UV sensitive gel is contained within a cartridge and the UV sensitive gel being configured to harden when exposed to a UV light source. The cartridge is removably contained within the body to allow for replacement cartridges when needed. The cartridge further has an ejection tip configured to allow the UV sensitive gel to expel from the cartridge and it is positioned about the tip end when the cartridge is contained within the body. A manual hand pump is attached to the body and in communication with the cartridge. The manual hand pump when pressed towards the body is configured to force the UV sensitive gel contained within the cartridge out through the ejection tip. In addition, when the UV sensitive gel is forced from the cartridge by pressing the manual hand pump and the UV LED light source is actuated, the UV sensitive gel hardens from exposure to the UV LED light source to form the 3-dimensional object.

In another aspect of the one or more embodiments, the cartridge can be defined by having a cartridge shell for housing the gel. The cartridge shell has a top end and a lower end that is in communication with the ejection tip. A rod extending from the top end towards the lower end is provided within the shell. The rod has a thread positioned around the rod and is configured to rotate when the manual hand pump is pressed towards the body. A movable head is positioned about the top end inside of the cartridge shell and is configured to ride the thread towards the lower end of the cartridge shell when the rod rotates. As such, gel contained in the cartridge shell between the lower end and the movable head is forced out of the ejection tip when the moveable head is moved towards the lower end of the cartridge shell by pressing the manual hand pump towards the body.

In another aspect of the one or more embodiment provides for the manual hand pump to include a lever pivotally attached at one end to the body. An abutment member is configured to slide within the body. The abutment member has an upper end extending to towards an underside of the lever and further has a rack on one side. A spring is positioned between the abutment member and the body, such that when the lever is pressed down towards the body, the abutment member is pushed downward compressing the spring and when the lever is released the spring acts to return the abutment member and lever away from the body to a rest position. A pinion gear is meshed to the rack on the abutment member such that the pinion gear rotates when the abutment member is moved. A gear train can be rotatably connecting the pinion gear to the rod defined by the cartridge. The gear train is configured to only rotate the rod when the abutment member is moved by pressing the lever.

In other aspects, the gear train is defined to have a dual claw member secured to the pinion gear. An open gear is provided and includes an internal ratchet configured to engage the dual claw member and to cause rotation of the open gear in a first direction when the pinion gear rotates. The open gear further has an external ratchet that is engaged by a pawl when the open gear rotates in a direction opposition the first direction. A cap cover is secured to the rod defined by the cartridge and meshed to the open gear such that rotation of the open gear in a first direction cause rotation of the rod and thus moves the moveable head towards the lower end of the cartridge shell.

In yet other aspects of the present invention the hand-held instrument may include a transparent cover over the UV light source and disposable protective lens covers configured to be removable from the cover with excess UV gel builds up on the lens covers.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIGS. 1A through 1C are perspective views of a 3D pen used to draw 3D structures and a base pedestal all in accordance with one or more embodiments of the present invention;

FIGS. 2A-2B are perspective views of a 3D pen in accordance with one or more embodiments of the present invention;

FIGS. 3A-3D are perspective views of a 3D pen showing an elongated body and internal components in accordance with one or more embodiments of the present invention;

FIGS. 4A-4B are perspective views of a 3D pen showing a manual extraction mechanism to extract or expel the gel from the gel cartridge in accordance with one or more embodiments of the present invention;

FIGS. 5A-5C are perspective views of a 3D pen showing internal components used with the manual extraction mechanism to extract or expel the gel from the gel cartridge in accordance with one or more embodiments of the present invention;

FIG. 6 is a perspective view of an end of a 3D pen showing the end cap of the pen in accordance with one or more embodiments of the present invention;

FIGS. 7A and 7B are perspective view of a 3D pen showing an end cover in accordance with one or more embodiments of the present invention;

FIG. 8 is a perspective view of a 3D pen showing interchangeable end tips in accordance with one or more embodiments of the present invention;

FIG. 9 is an schematic of the electric circuit of a 3D pen in accordance with one or more embodiments of the present invention; and

FIGS. 10A through 10D are perspective view of a 3D pen in accordance with one or more embodiments of the present invention.

### DETAILED DESCRIPTION OF THE INVENTION

The present disclosure describes a hand-held device that allows a user to “draw” a 3D structure easily and inexpensively. The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology. Like components are labeled with identical element numbers for ease of understanding.

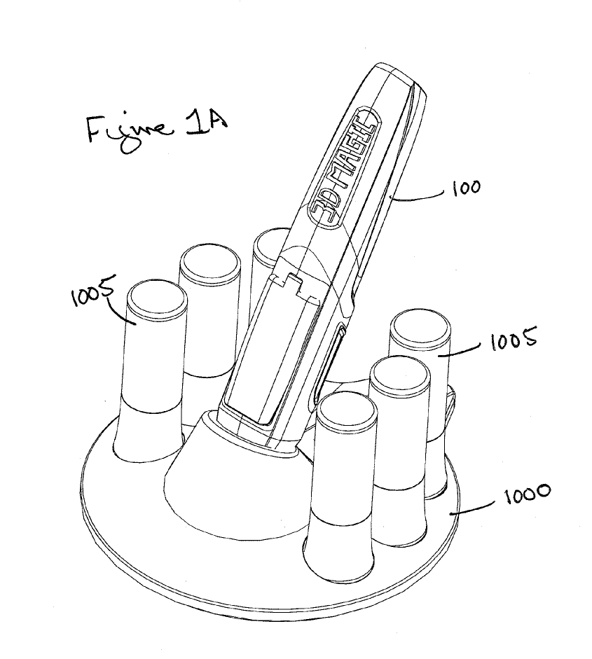

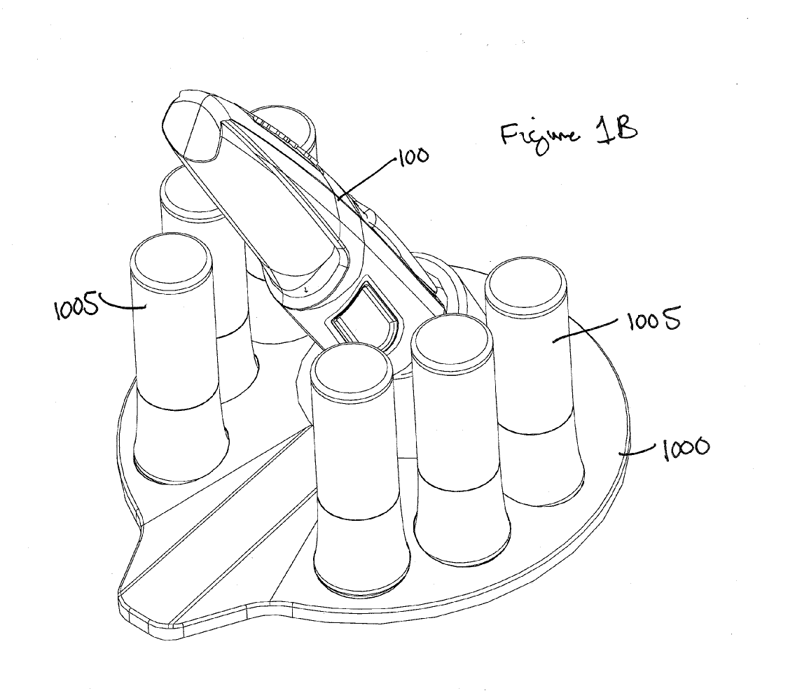

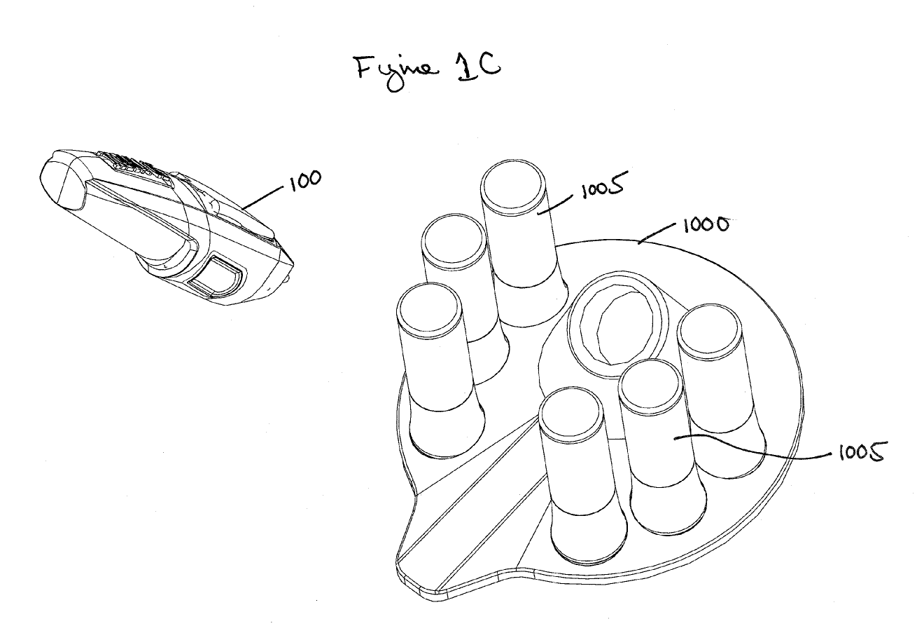

Referring now to FIGS. 1A-1C, there is shown a 3D Pen 100 in accordance with an embodiment of the present invention. The 3D Pen 100 is positioned and held by a base pedestal 1000 used to hold the pen 100 and additional replacement cartridges 1005. The replacement cartridges 1005 are used to holds a gel that is UV light sensitive that hardens when exposed to a UV light. As such the gel is kept soft or pliable within the cartridges but will harden when expelled from the cartridge or pen and then exposed to a UV light. The gel is not unique and there are many forms of the gel in the prior art.

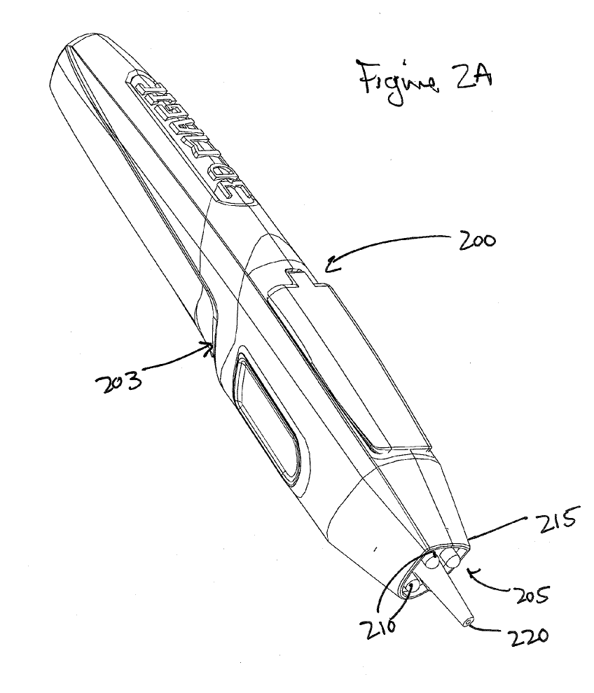

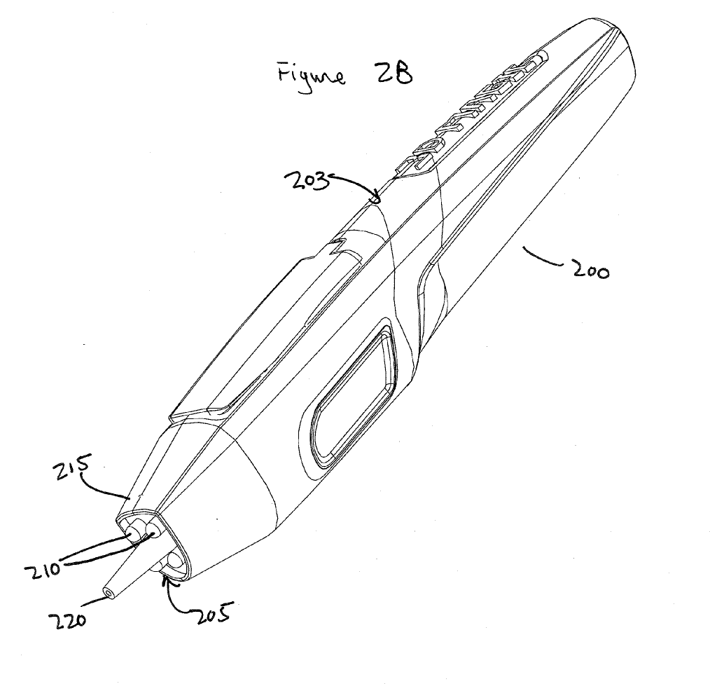

Referring now to FIGS. 2A and 2B there is shown a 3D hand held writing instrument (or as referred to herein as a “3D pen”) 200 that has an elongated body 203. The 3D pen 200 is used to expel a UV sensitive gel that hardens when exposed to a UV light source 205. The UV light source 205 may be one or more UV LEDs 210 positioned about one end 215 of the 3D pen 200. The end 215 is adjacent to and includes an ejection tip 220, which is configured to expel the gel.

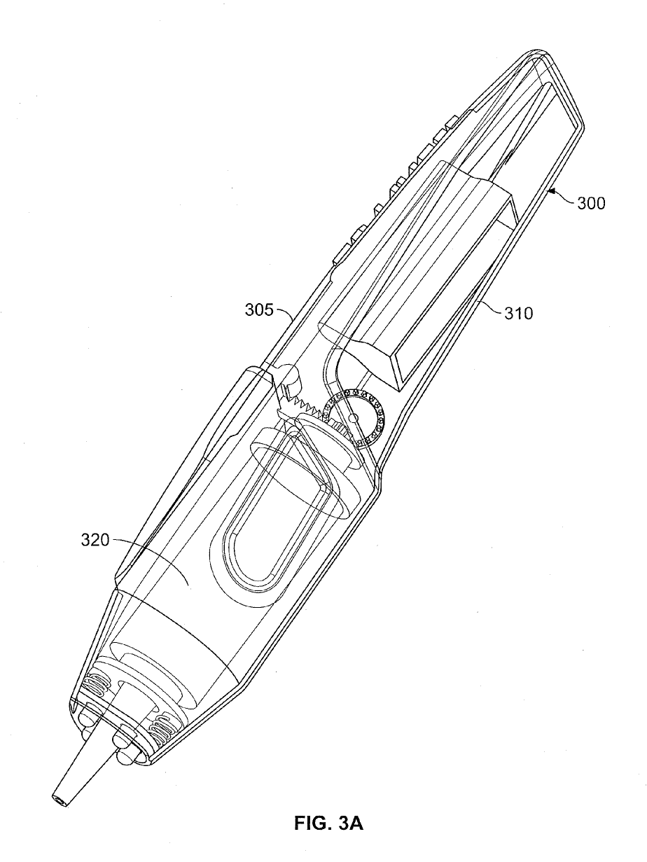

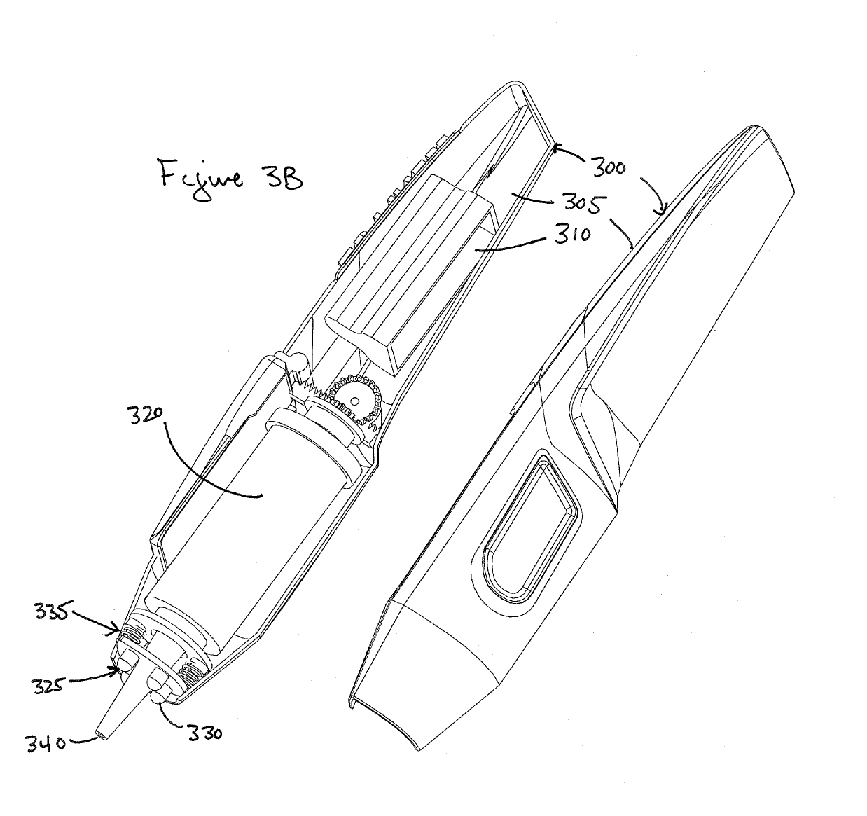

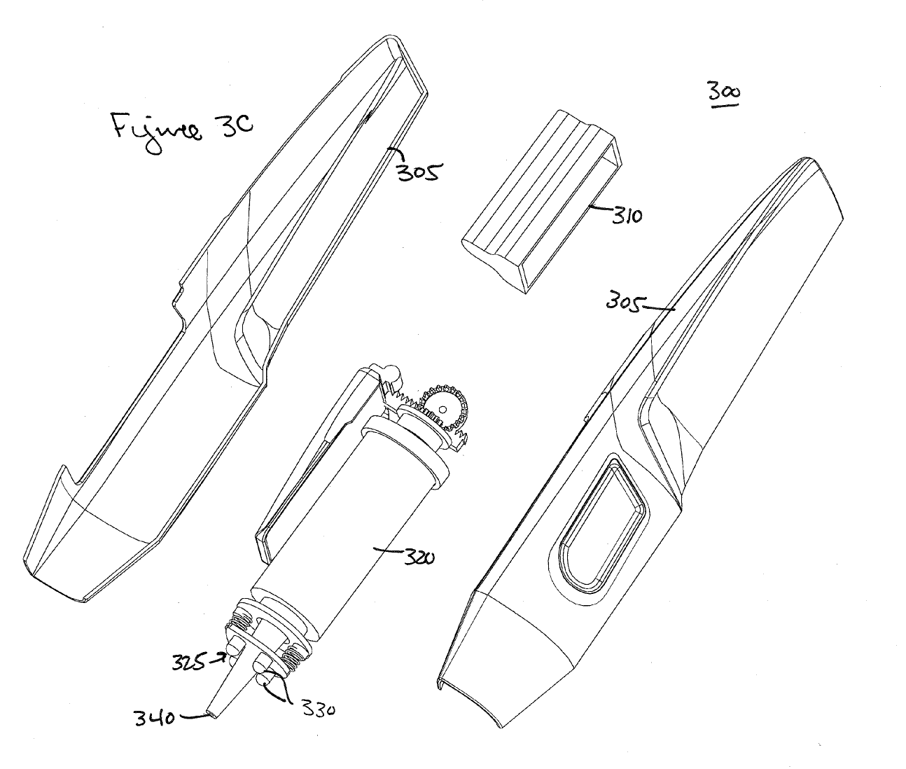

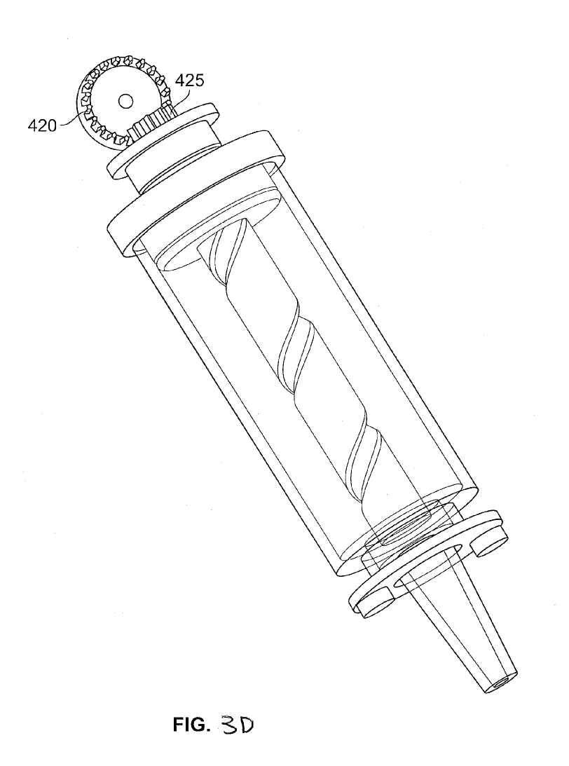

Referring now to FIGS. 3A through 3C there is shown a 3D pen 300 along with its internal components. The 3D pen 300 includes an elongated body 303 that is defined by a housing 305. The housing 305 may be configured in sections or halves that are secured together to form compartments. One compartment 310 may house a battery source (not shown). The battery compartment 310 would be used to store a replaceable or rechargeable battery source and used to power the UV light source. Another compartment may house a gel cartridge 320. The gel cartridge 320, as noted above, would be replaceable when the gel is running out or low. As noted, the 3D pen 300 includes a UV light source 325 (which may be one or more UV LEDs 330) positioned about one end 335 of the 3D pen 300. The end 335 is adjacent to and includes an ejection tip 340, which is configured to expel the gel from the gel cartridge 320.

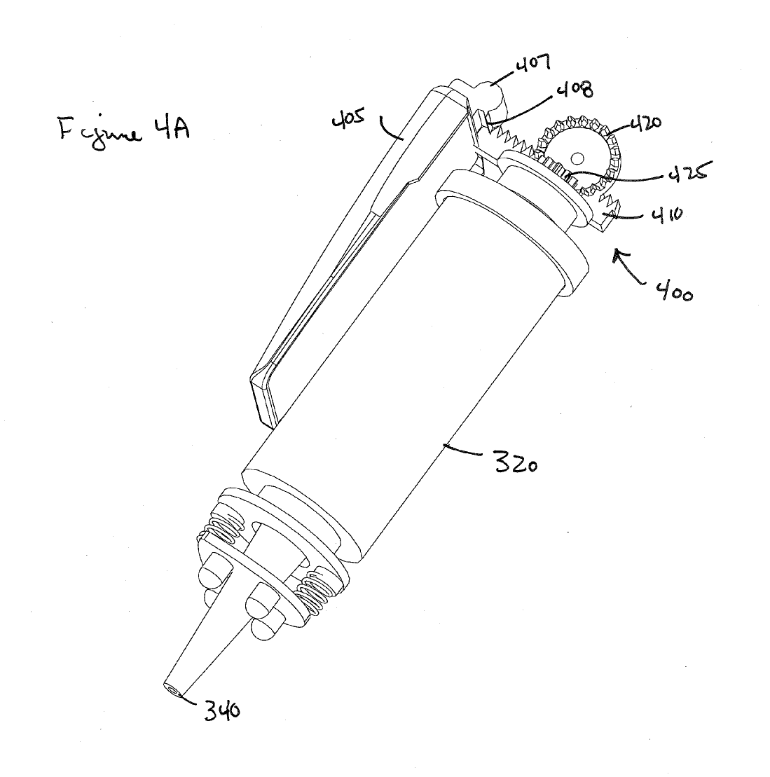

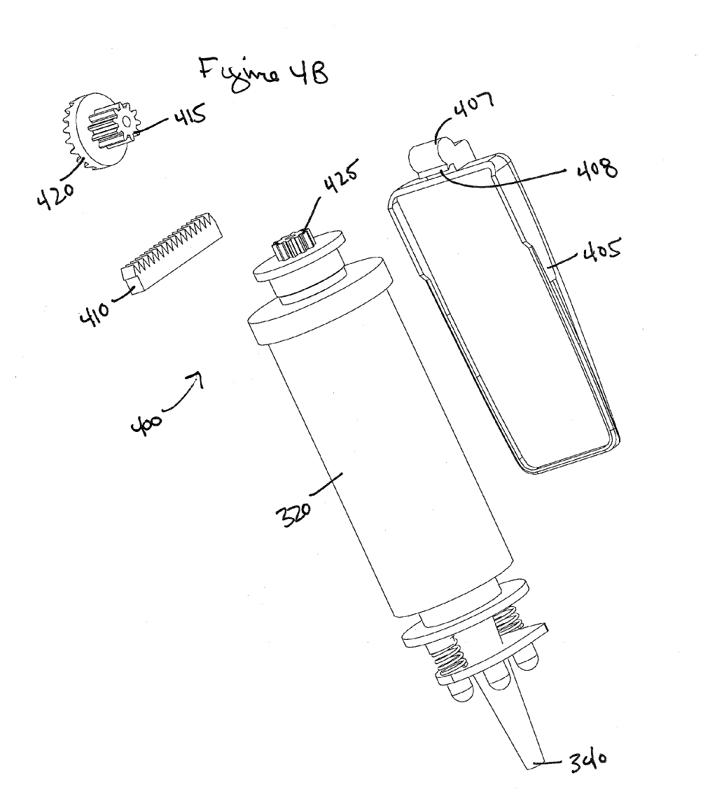

Referring now to FIGS. 4A-4B, one main notable difference between the present invention and prior art 3D written instruments is that the embodiments disclosed in accordance with the present invention does not include a motor to expel or extract the gel. Instead, the present invention utilizes a manual extraction mechanism 400 to expel or extract the gel from the gel cartridge 320. A hand pump 405 includes a head 407 with a flange tooth 408 that is engaged to a rack 410 and pinion gear 415. The pinion gear 415 is secured to a crown gear 420 that is meshed to cartridge gear 425. As such, when the manual extraction mechanism 400 is pressed towards the body 310 the cartridge gear 425 rotates.

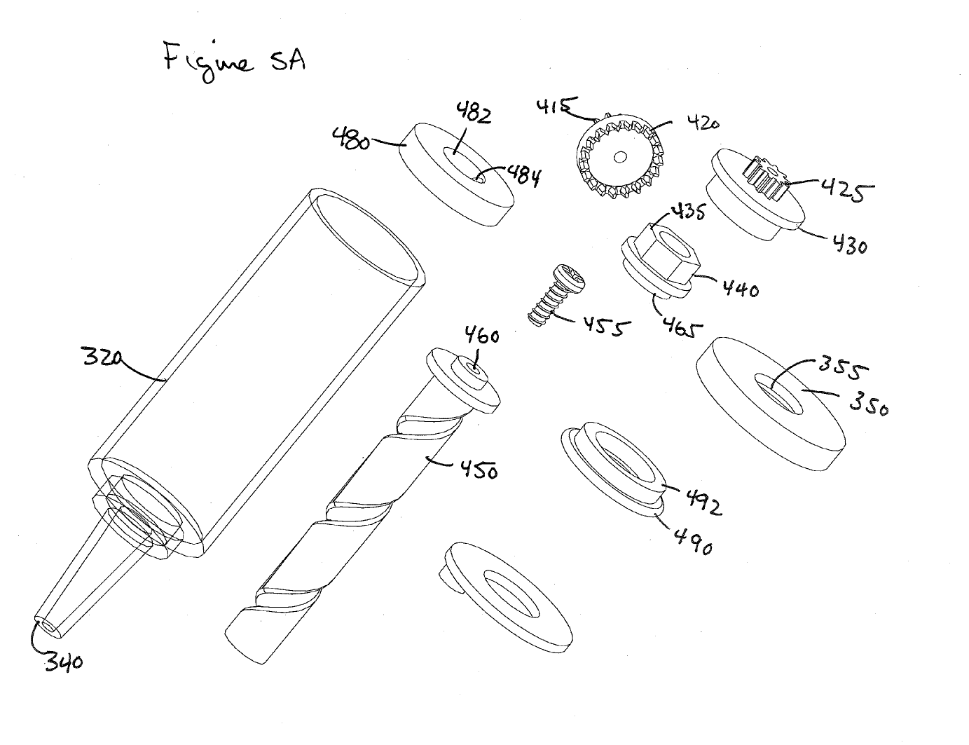

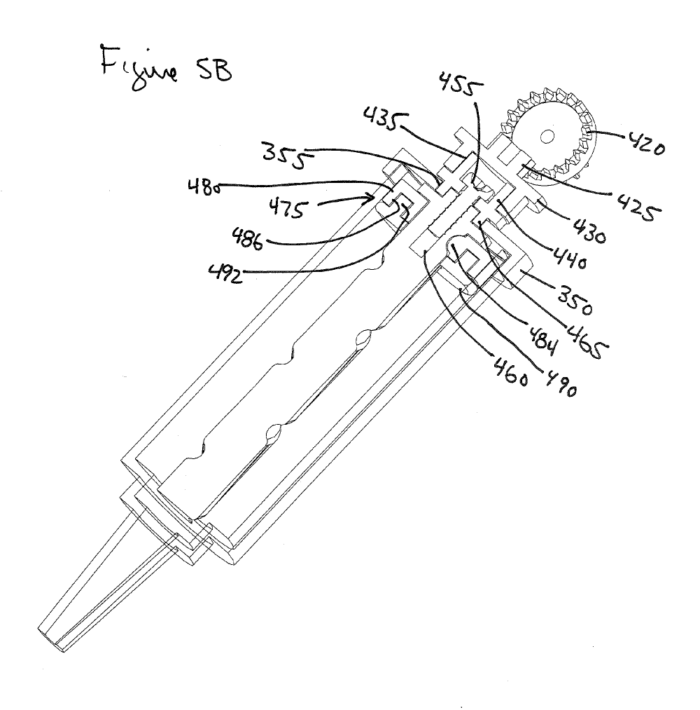

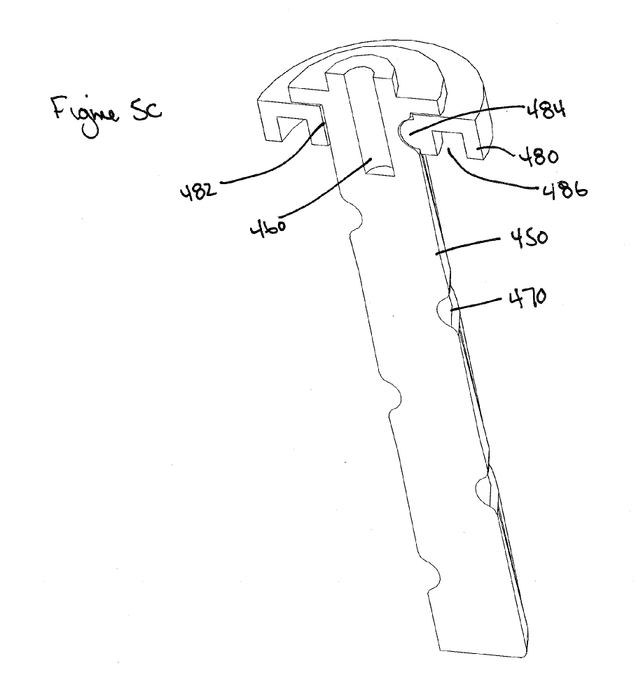

Referring now to FIGS. 5A-5C, to expel the gel from the gel cartridge 320 one or more embodiments of the present invention is configured to have the cartridge gear 425 attached to a cartridge cap 430 that includes a hex lock 435 under the cap 430. The hex lock 435 fits over a hex nut 440 that includes an internal bore 445 and that is configured to rest over an elongated cartridge screw 450 positioned within the gel cartridge 320. A fastener 455 is inserted through the internal bore 445 of the hex nut 440 and is used to secure the hex nut to the elongated cartridge screw 450 via a fastener thread 460. The elongated cartridge screw 450 includes a single channel thread 470 extending down and around the elongated cartridge screw 450.

A movable head 475 is positioned within the gel cartridge 320 and configured to have a diameter slightly smaller than the internal diameter of the gel cartridge such that the movable head 475 is capable of being moved down the gel cartridge pushes and forces the gel downwardly out through the end tip 340. The movable head 475 includes a top annual ring 480 that has an annual opening 482 sized to fit around the elongated cartridge screw 450. The top annual ring 480 includes a bead 484 positioned within the annual opening 482 and sized to fit in the single channel thread 470 of the elongated cartridge screw 450. The top annual ring 480 also includes an annual groove 486 on the underside thereof configured to receive an annual flange 492 extending upwardly from a bottom annual ring 490 such that the top annual ring and bottom annual ring are secured together. Both of which are thus secured within the gel cartridge and configured to move down as the elongated cartridge screw rotates along with the rotation of the cartridge gear 425.

In addition, the gel cartridge 320 includes a gel cover 350 over the top of the gel cartridge 320. The gel cover 350 includes an opening 355 sized to receive a bottom skirt 465 extending from the hex nut 440.

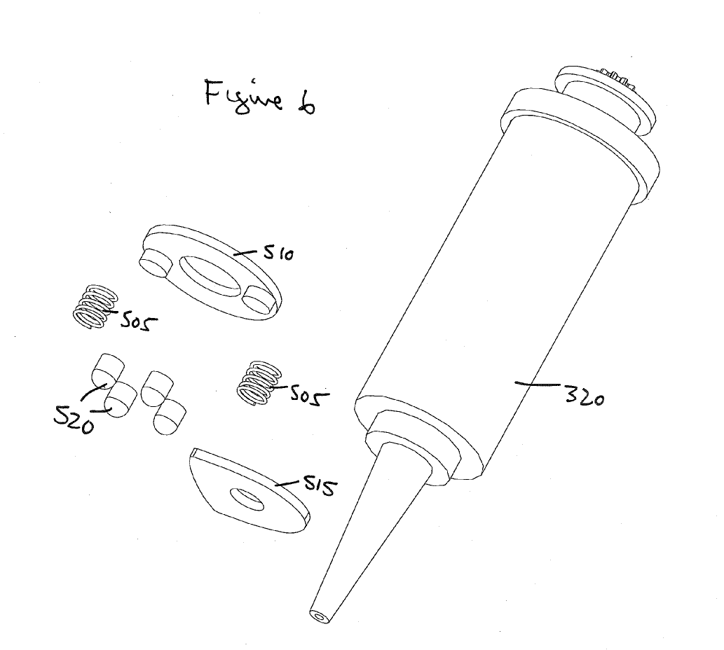

Referring now to FIG. 6, in one embodiment the gel cartridge 320 is positioned against one end of the 3D pen 300. The end of the 3D pen 300 may include an end cap 500 that is defined by a positioning springs 505 between a top plate 510 and a bottom plate 515. The plates and springs help keep the cartridge tightly positioned against the end of the housing. One or more UV LEDs 520 can be secured to the bottom plate 515.

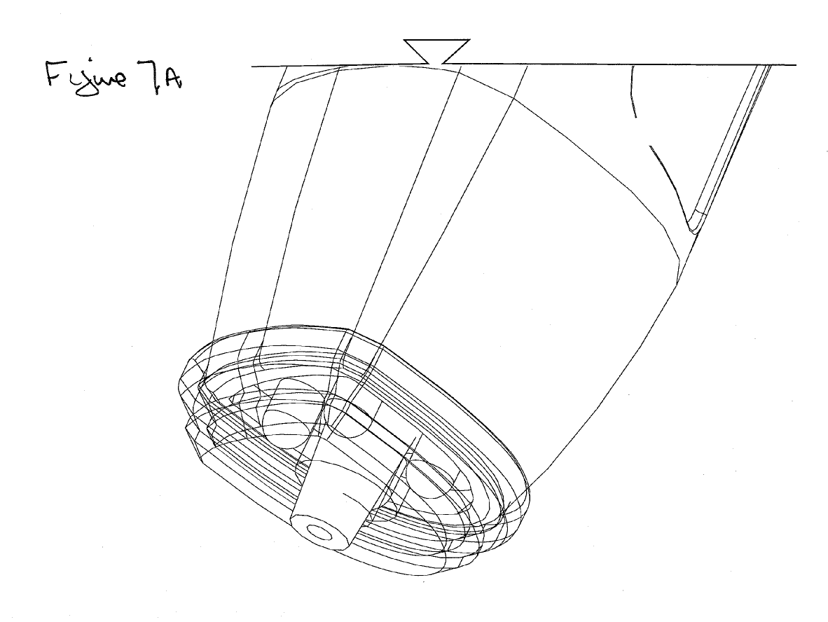

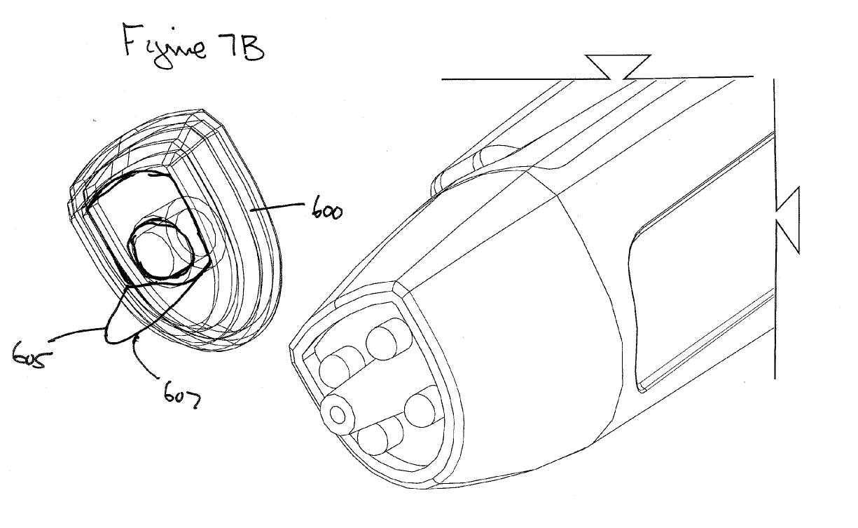

Referring now to FIGS. 7A and 7B, in one embodiment the end of the 3D pen 300 may include a transparent cover 600 over the UV light source 605. The cover 600 will help protect the UV light source from the UV gel. One problem that has appeared in the art is that exposed UV light sources can get covered with the gel and which when hardens prevents the UV light source from working properly and can eventually stop its use altogether. Moreover, when the UV gel hardens it becomes extremely difficult to remove from a surface such that it becomes virtually impossible to clean the UV light source. One solution is to have the cover 600. Another solution would be to include disposable protective lens covers 605 over the UV light source. The disposable lens covers 605 could be removable or tear away such that the user can simply tear away when it becomes covered with gel. The disposable covers 605 could have an adhesive 607 on one side such that it can easily apply and stick to the cover 600 or UV light source.

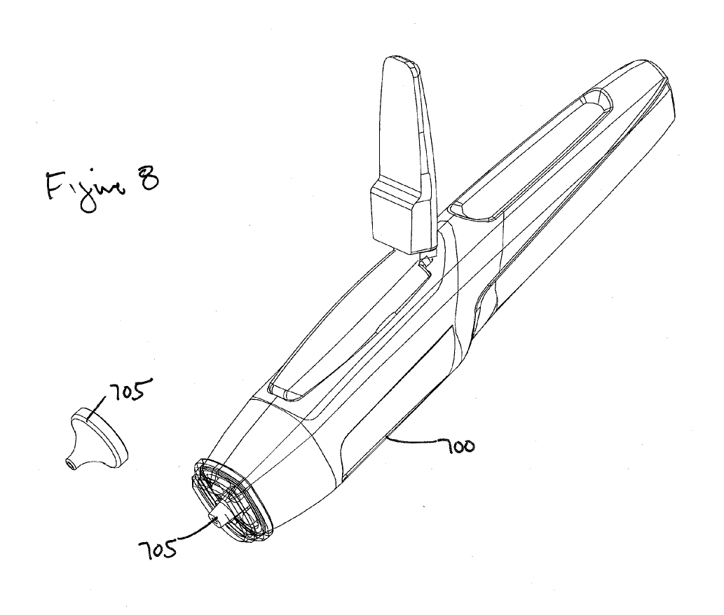

Referring now to FIG. 8, in another embodiment the 3D pen 700 may include interchangeable end tips 705. The interchangeable end tips 705 may allow the user to use smaller nozzle ejection points or even an end tip with an embedded design such that the gel is capably of coming out in different shapes.

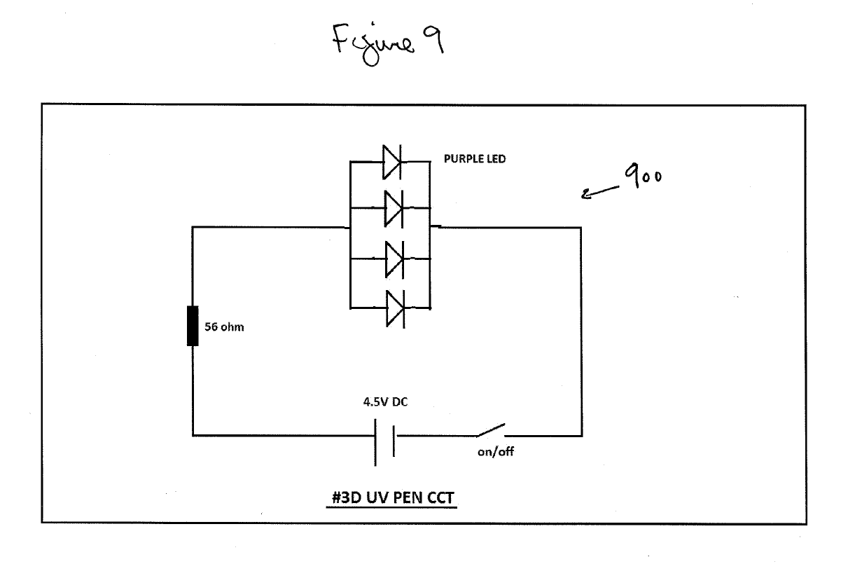

In one or more embodiments of the present invention it was found that the LED light source specification works with an about 5 mm round LED lamp with a wave length peak of about 402 nm. In addition, the schematic shown in FIG. 9 illustrates a circuit diagram 900 for the LED light source.

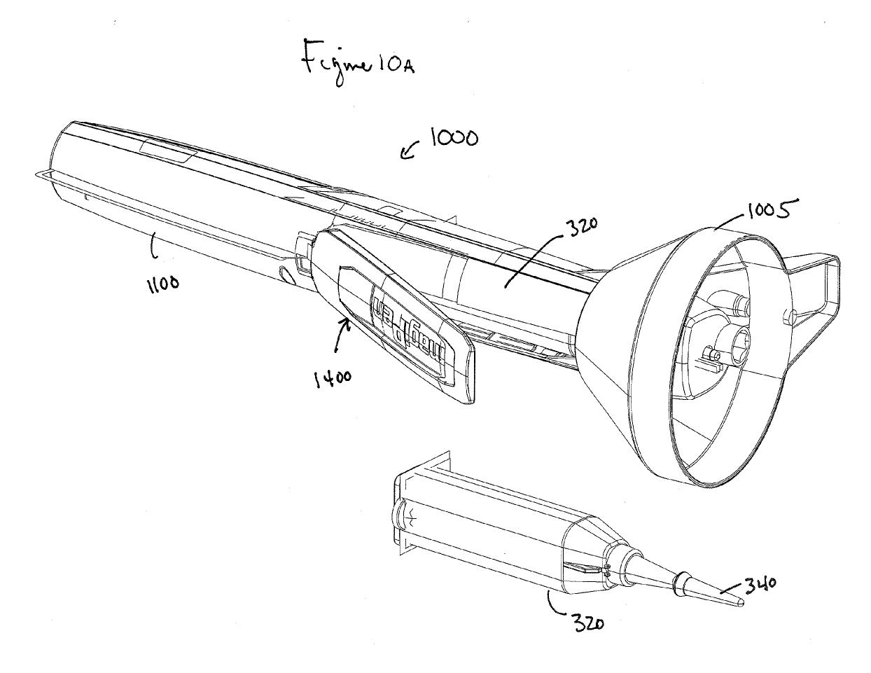

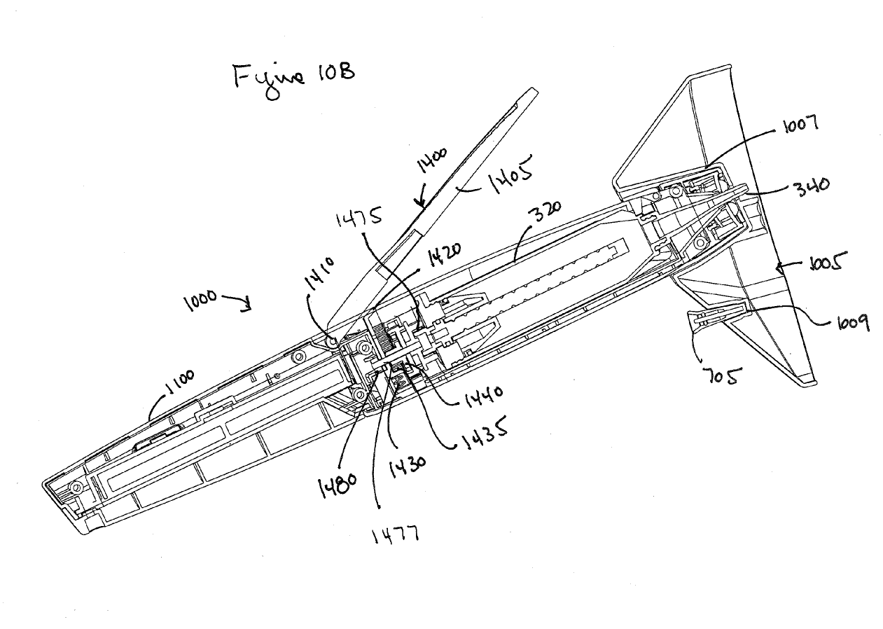

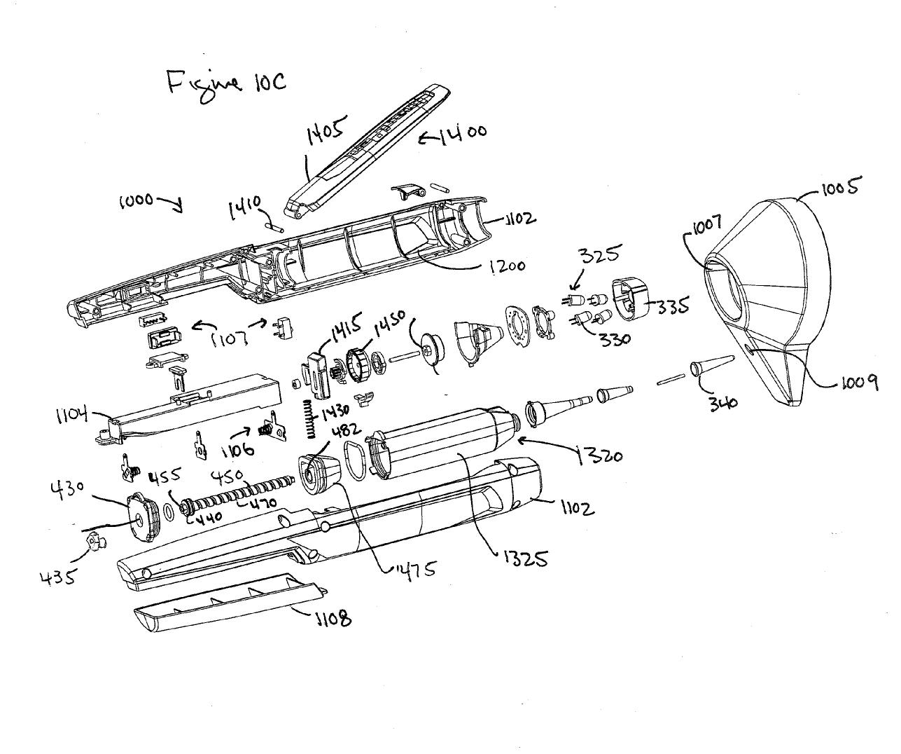

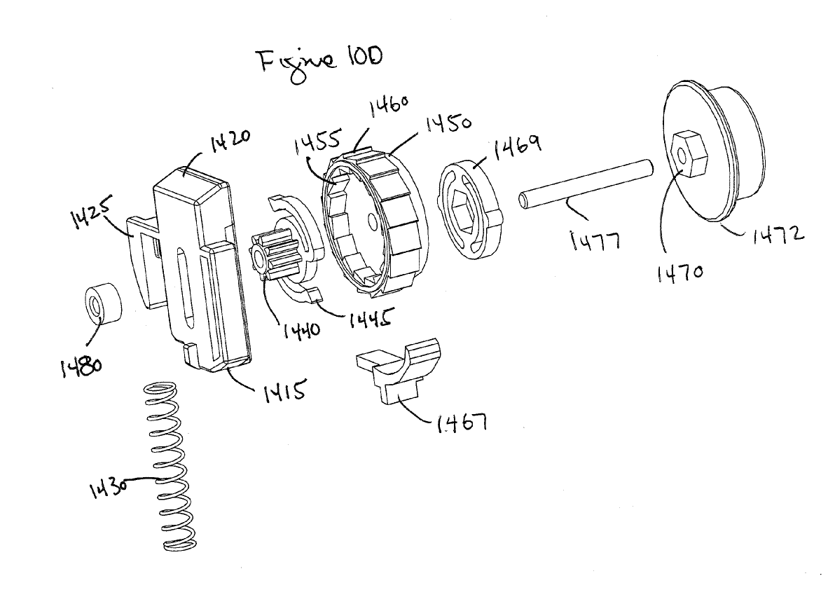

In another embodiment of the present invention, illustrated in FIGS. 10A-10D, there is shown a 3D Pen 1000. In FIG. 10A the pen 1000 is shown with a base 1005 that can rest on a surface and allow the pen 1000 to stand upright (similar to FIG. 1A). In this embodiment the base 1005 includes an main opening 1007 to hold the pen 1000 and a secondary opening 1009 to hold a second interchangeable or replacement tip 705. The pen 1000 includes an elongated body 1100 that is illustrated as a two piece housing body 1102 that has a battery source compartment section 1104 that is fit to one end of the housing body 1102. The battery source compartment section 1104 further includes the necessary battery compartment components 1106 and circuit components 1107 to allow and communicate power from the battery source (not shown) to the UV light source 325 and further includes a cover 1108. Along the opposite end to the battery source compartment section is a secondary compartment section 1200 configured to house the gel cartridge 320. As noted above the pen 1000 includes a manual extraction mechanism 1400 to expel or extract the gel from the gel cartridge 1320.

The gel cartridge 1320 includes a cartridge shell 1325 used to house the gel and components. The gel cartridge 1320 includes a cartridge cap 430 that includes a hex lock 435 that is positioned through the cartridge cap 430 to secure onto a fastener 455 that is secured to the elongated cartridge screw 450. A movable head 475 is positioned within the gel cartridge 320 and rides the screw 450 to force gel out of the cartridge. Other components are similarly defined above.

The manual pump mechanism 1400 can be defined to include a lever 1405 accessible by a user externally to the body 1100. The lever 1405 includes a pivot end 1410 that is pivotally attached to the body 1100. Abutting the underside of the lever 1405 adjacent the pivot end 1410 is a slideable abutment member 1415. The abutment member 1415 is slidably mounted within the body 1100 and includes an upper end 1420 extending out of the body 1100 to make contact with the underside of the lever 1405. The abutment member 1415 further includes an arm 1425 that holds in place a spring 1430. When the lever 1405 is pressed down by a user the abutmemt member 1415 is pushed downward against the spring 1430, and when the lever 1405 is released the spring 1430 forces the abutment member 1415 back to its resting position and thus presses the lever 1405 upwardly. The abutment member 1415 includes a rack 1435 on a side that faces a pinion 1440. The pinion 1440 is secured to a dual claw member 1445 that further sits within an open gear 1450 that includes an internal ratchet 1455. When the abutment member 1415 slides down, the pinion 1440 rotates causing the dual claw member 1445 to rotate and turn the open gear 1450. The open gear 1450 further includes an external ratchet 1460 that engages a pawl 1467 that is mounted to the body 1100. As such, when the abutment member 1415 slides upwardly, the reverse rotation of the pinion 1440 does not cause a reverse rotation of the open gear 1450 as both the dual claw member only causes rotation in one direction and the pawl engages the external ratchet to help prevent reverse rotation. Mounted to the open gear 1450 is a cap cover 1469 that fits over a cap nut 1470 that is secured to a cap 1472. The cap 1472 includes on the underside an opening with a profile 1475 to engage with the hex lock 435. As such when the open gear 1450 rotates, the cap 1465 and thus the screw 450 rotates therewith. These are all mounted on an axle 1477 that is positioned at one end within a bearing 1480 positioned in the body.

This application includes description that is provided to enable a person of ordinary skill in the art to practice the various aspects described herein. While the foregoing has described what are considered to be the best mode and/or other examples, it is understood that various modifications to these aspects will be readily apparent to those skilled in the art, and the generic principles defined herein may be applied to other aspects. It is understood that the specific order or hierarchy of steps or blocks in the processes disclosed is an illustration of exemplary approaches. Based upon design preferences, it is understood that the specific order or hierarchy of steps or blocks in the processes may be rearranged. The accompanying method claims present elements of the various steps in a sample order, and are not meant to be limited to the specific order or hierarchy presented. Thus, the claims are not intended to be limited to the aspects shown herein, but is to be accorded the full scope consistent with the language claims.

Headings and subheadings, if any, are used for convenience only and do not limit the invention. Reference to an element in the singular is not intended to mean “one and only one” unless specifically so stated, but rather “one or more.” Use of the articles “a” and “an” is to be interpreted as equivalent to the phrase “at least one.” Unless specifically stated otherwise, the terms “a set” and “some” refer to one or more. Terms such as “top,” “bottom,” “upper,” “lower,” “left,” “right,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

Although the relationships among various components are described herein and/or are illustrated as being orthogonal or perpendicular, those components can be arranged in other configurations in some embodiments. For example, the angles formed between the referenced components can be greater or less than 90 degrees in some embodiments. Although various components are illustrated as being flat and/or straight, those components can have other configurations, such as curved or tapered for example, in some embodiments.

Pronouns in the masculine (e.g., his) include the feminine and neuter gender (e.g., her and its) and vice versa. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “operation for.”

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. A phrase such as an embodiment may refer to one or more embodiments and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. Furthermore, to the extent that the term “include,” “have,” or the like is used in the description or the claims, such term is intended to be inclusive in a manner similar to the term “comprise” as “comprise” is interpreted when employed as a transitional word in a claim.

Although embodiments of the present disclosure have been described and illustrated in detail, it is to be clearly understood that the same is by way of illustration and example only and is not to be taken by way of limitation, the scope of the present invention being limited only by the terms of the appended claims.

We claim:

1. A hand-held instrument for creating a 3-dimensional object, comprising:
a hand-held elongated body having a tip end and a base end;
at least one UV LED light source is positioned about the tip end, the UV LED light source selectively forming an electrical circuit with a battery contained within said body and a switch actuated externally from the body;
a UV sensitive gel is contained within a cartridge, the UV sensitive gel being configured to harden when exposed to a UV light source, and the cartridge is removably contained within the body, the cartridge further having an ejection tip configured to allow the UV sensitive gel to expel from the cartridge and positioned about the tip end when the cartridge is contained within the body; and
a manual hand pump is attached to the body and is in communication with the cartridge, the manual hand pump when pressed towards the body is configured to force the UV sensitive gel contained within the cartridge out through the ejection tip,
wherein when the UV sensitive gel is forced from the cartridge by pressing the manual hand pump and the UV LED light source is actuated, the UV sensitive gel hardens from exposure to the UV LED light source to form the 3-dimensional object.

2. The hand-held instrument for creating a 3-dimensional object of claim 1, wherein the cartridge includes:
a cartridge shell for housing the gel, the cartridge shell having a top end and a lower end, the lower end in communication with the ejection tip;
a rod extending from the top end towards the lower end, the rod have a thread positioned around the rod and the rod in configured to rotate when the manual hand pump is pressed towards the body; and
a movable head positioned about the top end inside of the cartridge shell and configured to ride the thread towards the lower end of the cartridge shell when the rod rotates, wherein gel contained in the cartridge shell between the lower end and the movable head is forced out of the ejection tip when the moveable head is moved towards the lower end of the cartridge shell by pressing the manual hand pump towards the body.

3. The hand-held instrument for creating a 3-dimensional object of claim 2, wherein the manual hand pump includes:
a lever pivotally attached at one end to the body;
an abutment member configured to slide within the body, the abutment member having an upper end extending to towards an underside of the lever, the abutment member further having a rack on one side;
a spring positioned between the abutment member and the body, and wherein when the lever is pressed down towards the body, the abutment member is pushed downward compressing the spring such then when the lever is released the spring acts to return the abutment member and lever away from the body to a rest position;
a pinion gear meshed to the rack on the abutment member such that the pinion gear rotates when the abutment member is moved; and
a gear train rotatably connecting the pinion gear to the rod defined by the cartridge, the gear train configured to only rotate the rod when the abutment member is moved by pressing the lever.

4. The hand-held instrument for creating a 3-dimensional object of claim 3, wherein the gear train is defined by having:
a dual claw member secured to the pinion gear;
an open gear having an internal ratchet configured to engage the dual claw member and to cause rotation of the open gear in a first direction when the pinion gear rotates, the open gear further having an external ratchet;
a pawl positioned to engage the eternal ratchet when the open gear rotates in a direction opposition the first direction;
a cap cover secured to the rod defined by the cartridge and meshed to the open gear such that rotation of the open gear in a first direction cause rotation of the rod and thus moves the moveable head towards the lower end of the cartridge shell.

5. The hand-held instrument for creating a 3-dimensional object of claim 1 further comprising:
a transparent cover over the UV light source and disposable protective lens covers positioned over the cover, the disposable lens covers configured to be removable from the cover.

6. The hand-held instrument for creating a 3-dimensional object of claim 1, wherein the manual hand pump includes:
a lever pivotally attached at one end to the body;
an abutment member configured to slide within the body, the abutment member having an upper end extending to towards an underside of the lever, the abutment member further having a rack on one side;
a spring positioned between the abutment member and the body, and wherein when the lever is pressed down towards the body, the abutment member is pushed downward compressing the spring such then when the lever is released the spring acts to return the abutment member and lever away from the body to a rest position;
a pinion gear meshed to the rack on the abutment member such that the pinion gear rotates when the abutment member is moved; and
a gear train rotatably connecting the pinion gear to a mechanism defined within the cartridge and the mechanism configured to force the UV gel out of the cartridge when when the abutment member is moved by pressing the lever.

7. The hand-held instrument for creating a 3-dimensional object of claim 6, wherein the cartridge includes:
a cartridge shell for housing the gel, the cartridge shell having a top end and a lower end, the lower end in communication with the ejection tip;
a rod extending from the top end towards the lower end, the rod have a thread positioned around the rod and the rod in configured to rotate when the manual hand pump is pressed towards the body; and
a movable head positioned about the top end inside of the cartridge shell and configured to ride the thread towards the lower end of the cartridge shell when the rod rotates, wherein gel contained in the cartridge shell between the lower end and the movable head is forced out of the ejection tip when the moveable head is moved towards the lower end of the cartridge shell by pressing the manual hand pump towards the body.

8. The hand-held instrument for creating a 3-dimensional object of claim 7, wherein the gear train is defined by having:
a dual claw member secured to the pinion gear;
an open gear having an internal ratchet configured to engage the dual claw member and to cause rotation of the open gear in a first direction when the pinion gear rotates, the open gear further having an external ratchet;
a pawl positioned to engage the eternal ratchet when the open gear rotates in a direction opposition the first direction;
a cap cover secured to the rod defined by the cartridge and meshed to the open gear such that rotation of the open gear in a first direction cause rotation of the rod and thus moves the moveable head towards the lower end of the cartridge shell.

9. A hand-held instrument for creating a 3-dimensional object, comprising:
a hand-held elongated body having a tip end and a base end;
at least one UV LED light source is positioned about the tip end, the UV LED light source selectively forming an electrical circuit with a battery contained within said body and a switch actuated externally from the body;
a UV sensitive gel is contained within a cartridge, the UV sensitive gel being configured to harden when exposed to a UV light source, and the cartridge is removably contained within the body, the cartridge further having an ejection tip configured to allow the UV sensitive gel to expel from the cartridge and positioned about the tip end when the cartridge is contained within the body;
a manual hand pump is attached to the body and is in communication with the cartridge, the manual hand pump when pressed towards the body is configured to force the UV sensitive gel contained within the cartridge out through the ejection tip;
wherein when the UV sensitive gel is forced from the cartridge by pressing the manual hand pump and the UV LED light source is actuated, the UV sensitive gel hardens from exposure to the UV LED light source to form the 3-dimensional object and
a transparent cover over the UV light source and disposable protective lens covers positioned over the cover, the disposable lens covers configured to be removable from the cover.

10. The hand-held instrument for creating a 3-dimensional object of claim 9, wherein the cartridge includes:
a cartridge shell for housing the gel, the cartridge shell having a top end and a lower end, the lower end in communication with the ejection tip;
a rod extending from the top end towards the lower end, the rod have a thread positioned around the rod and the rod in configured to rotate when the manual hand pump is pressed towards the body; and
a movable head positioned about the top end inside of the cartridge shell and configured to ride the thread towards the lower end of the cartridge shell when the rod rotates, wherein gel contained in the cartridge shell between the lower end and the movable head is forced out of the ejection tip when the moveable head is moved towards the lower end of the cartridge shell by pressing the manual hand pump towards the body.

11. The hand-held instrument for creating a 3-dimensional object of claim 10, wherein the manual hand pump includes:
a lever pivotally attached at one end to the body;
an abutment member configured to slide within the body, the abutment member having an upper end extending to towards an underside of the lever, the abutment member further having a rack on one side;
a spring positioned between the abutment member and the body, and wherein when the lever is pressed down towards the body, the abutment member is pushed downward compressing the spring such then when the lever is released the spring acts to return the abutment member and lever away from the body to a rest position;
a pinion gear meshed to the rack on the abutment member such that the pinion gear rotates when the abutment member is moved; and
a gear train rotatably connecting the pinion gear to the rod defined by the cartridge, the gear train configured to only rotate the rod when the abutment member is moved by pressing the lever.

12. The hand-held instrument for creating a 3-dimensional object of claim 11, wherein the gear train is defined by having:
a dual claw member secured to the pinion gear;
an open gear having an internal ratchet configured to engage the dual claw member and to cause rotation of the open gear in a first direction when the pinion gear rotates, the open gear further having an external ratchet;
a pawl positioned to engage the eternal ratchet when the open gear rotates in a direction opposition the first direction;
a cap cover secured to the rod defined by the cartridge and meshed to the open gear such that rotation of the open gear in a first direction cause rotation of the rod and thus moves the moveable head towards the lower end of the cartridge shell.
